(19) United States
(12) Patent Application Publication
(10) Pub. No.: US 2009/0317586 A1
(43) Pub. Date: Dec. 24, 2009

(54) REFRIGERATING APPLIANCE

(75) Inventors: Adolf Feinauer, Giengen (DE); Erich Hell, Giengen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/519,569

(22) PCT Filed: Dec. 7, 2007
(86) PCT No.: PCT/EP07/63499

§ 371 Date: Jun. 17, 2009

(30) Foreign Application Priority Data
Dec. 22, 2006 (DE) 10 2006 061 085.7

(51) Int. Cl. F25D 23/06; B32B 3/12

(52) U.S. Cl. 428/117; 428/116; 428/118

(57) ABSTRACT

A refrigerating appliance is provided that includes a cold generator and a cooled inner region surrounded by heat-insulated walls. The individual walls are formed from evacuated moulded parts and connected to form a housing and the moulded parts have a honeycombed supporting structure that is surrounded by a gastight outer skin.

The invention relates to a heat-insulating wall according to the preamble of claim 1.

Heat-insulating wall structures of refrigerating appliances such as refrigerators or refrigerator/freezer combinations today usually comprise an inner shell which is anchored in an outer housing comprising a cover, base, side walls and rear wall. Once the refrigeration unit and the electrical components are mounted, the intermediate space between the inner shell and the outer housing is filled with foam. This procedure is relatively complex and therefore expensive.

Transportable cool boxes of relatively small size are produced more economically. Pre-fabricated vacuum panels which are assembled into a suitable housing are used for constructing these cool boxes. These vacuum panels usually comprise a gas-tight outer skin which encloses a molded body which comprises compressed bulk material. Silica or aerogels are used as the bulk material. These panels are evacuated and sealed. This achieves a limited degree of stiffness and stability. However, the strength of these vacuum panels is insufficient to construct a refrigerating appliance of the usual size.

The underlying object of the invention is to construct a heat-insulating wall so that it can be economically produced but still possesses the necessary strength and stability.

This object is achieved according to the invention with a heat-insulating wall having the features of claim 1. Heat-insulating walls having a honeycomb-shaped support frame can be produced with a degree of stiffness which also permits the construction of relatively large housings. These walls, which have a gas-tight outer skin and are evacuated, can be joined to form a housing and so delimit the interior of the refrigerating appliance or can be embodied as a refrigerating appliance housing with a door attached, or as vacuum insulation panels, which are anchored in the foam insulation of the refrigerating appliances.

The honeycomb cells of the support frame are advantageously filled with bulk material. This further increases the strength while simultaneously producing a smoother surface, since the outer skin cannot become pressed into the honeycomb-shaped structure.

The bulk material for filling the honeycomb-shaped structure of the support body advantageously comprises silica and/or aerogels. These materials have proved their value in the known heat-insulating walls based on vacuum insulation techniques and ensure excellent insulating effects. As a consequence, a housing with a high degree of strength and excellent insulating properties can therefore be constructed for refrigerating appliances from the heat-insulating walls thus manufactured.

Since the honeycomb-shaped support frame is made from a solid material, a certain amount of heat transmission takes place through the support frame from the outside to the inside. The support frame is therefore advantageously divided into a plurality of layers which are offset relative to one another. As a result, the heat transmission from one layer to the next can only take place at points. This enables the insulating properties to be further improved. Ideally, the support frame is constructed from four layers. By offsetting the individual layers, all the hollow spaces are made to communicate with one another. Filling with bulk material can therefore be made substantially easier.

With a layer thickness of 5 mm, a housing for a refrigerating appliance which has a thickness of only 2 cm is produced. The insulating effect of this housing is far better than that of the foam-filled housings which are usual nowadays. Due to the mutual offset of the four layers, the strength is also increased to the extent that the stability of the housing is directly comparable with the housings that are common nowadays.

The honeycomb cells of the support frame can be rectangular in shape, but greater strength can be achieved with a hexagonal honeycomb structure.

The molded parts can be made with different configurations. For example, the rear wall can have a step under which the compressor of the refrigeration unit is accommodated. Ideally, however, the molded parts are produced as flat panels. This facilitates assembly and makes production of both the individual molded parts and the refrigerating appliance more economical.

Further details and advantages of the invention emerge from the subclaims in conjunction with the description of an exemplary embodiment, making reference to the drawings, in which:

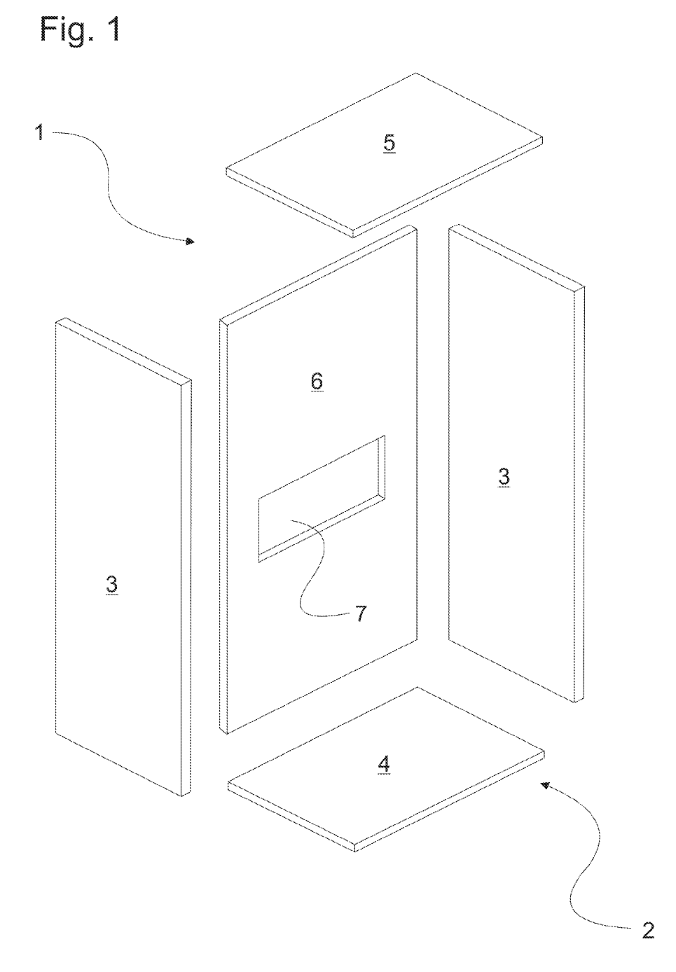

FIG. 1 is an exploded view of the housing of a refrigerating appliance according to the invention, and

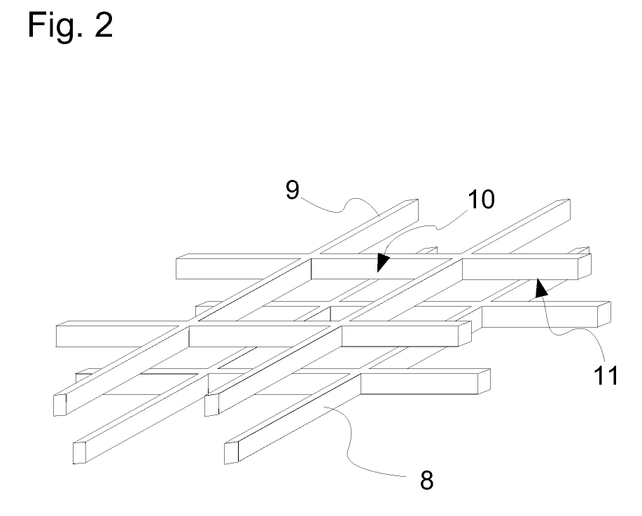

FIG. 2 is a section of the support frame of a vacuum panel.

The invention will now be described by way of example with reference to a refrigerating appliance constructed from heat-insulating wall parts.

FIG. 1 shows a refrigerating appliance 1 of this type, the internal space 2 of which is delimited by two side walls 3, a base 4, a cover 5, and a rear wall 6. The associated door is not shown here. The side walls 3, the base 4, the cover 5 and the rear wall 6 comprise vacuum panels with a honeycomb-shaped support frame, as shown in FIG. 2. The panels are configured such that their narrow sides also do not represent heat bridges. They are joined at the manufacturing site to a housing in such a way that the joining technique also prevents any heat passing from outside into the internal space. The rear wall 6 has an aperture 7 approximately in the centre in the exemplary embodiment shown, said aperture being formed so that a Peltier element can be placed therein.

FIG. 2 shows a two-layered support frame with rectangular honeycomb cells 10. The upper layer 9 is arranged offset relative to the lower layer 8. Transmission of heat from the lower layer 8 to the upper layer 9 can therefore only take place via the contact points 11. This enables the heat transmission to be greatly reduced. With a four-layered arrangement which, for reasons of clarity is not shown here, the heat transmission between the upper and lower layers is still further reduced.

Due to the offset of the layers 8 and 9, the honeycomb cells 10 communicate with one another. The cells 10 can therefore be filled without difficulty. In a four-layered arrangement, the filling is still simpler due to the additional connections provided between the honeycomb cells 10.

Any housing for a refrigerating appliance can be realized using the molded parts described herein. If the refrigeration unit is constructed in the conventional manner from a compressor, a condenser and an evaporator, the rear wall usually has a step so that the compressor can be mounted on the outside under this step. A molded part having this configuration can also be produced with the support frame.

In the housing shown in FIG. 1, all the delimiting walls 3, 4, 5 and 6 are made from suitably constructed flat vacuum panels. The use of a Peltier element in the aperture 7 as the refrigeration unit means that the rear wall 6 does not need to have a step for accommodating a compressor. All the delimiting walls can be made in the same way. A refrigerating appliance constructed in this way can be made very economically and has excellent insulating properties. The support frame in the panels also gives the housing the necessary load bearing capacity.

### LIST OF REFERENCE NUMBERS

1 Refrigerating appliance
2 Internal space
3 Side walls
4 Base
5 Cover
6 Rear wall
7 Aperture
8 Lower layer of the support frame
9 Upper layer of the support frame
10 Honeycomb cells
11 Contact points

1-8. (canceled)

9. A heat-insulating wall comprising:
at least one honeycomb-shaped support frame; and
a substantially gas-tight outer skin enclosing the at least one honey-combed shape support frame, the heat-insulating wall being assemblable in a refrigerating appliance in a configuration in which the heat-insulating wall and other heat-insulating walls delimit an area in which a refrigeration unit and a cooled of the refrigerating appliance are located.

10. The heat-insulating wall as claimed in claim 9, wherein the support frame has a plurality of honeycomb cells and the honeycomb cells of the support frame are filled with bulk material.

11. The heat-insulating wall as claimed in claim 10, wherein the bulk material is formed from at least one of silica and aerogels.

12. The heat-insulating wall as claimed in claim 9, wherein the support frame has a plurality of layers and the layers are arranged offset relative to one another.

13. The heat-insulating wall as claimed in claim 12, wherein the support frame has four layers.

14. The heat-insulating wall as claimed in claim 12, wherein each layer has a thickness of 5 mm.

15. The heat-insulating wall as claimed in claim 9, wherein the support frame has a plurality of honeycomb cells and the honeycomb cells of the support frame are hexagonal in shape.

16. A refrigerating appliance comprising:
a refrigeration unit;
a cooled internal space; and
a plurality of heat-insulating wall including at least one heat-insulating wall formed of at least one honeycomb-shaped support frame and a substantially gas-tight outer skin enclosing the at least one honey-combed shape support frame, the heat-insulating wall walls delimiting an area in which the refrigeration unit and the cooled internal space of the refrigerating appliance are located.
